(19) United States
(12) Patent Application Publication
(10) Pub. No.: US 2012/0203690 A1
(43) Pub. Date: Aug. 9, 2012

(54) Search Engine System And Information Searching Method

(75) Inventors: Haisong YANG, Shenzhen City (CN); Liang SUN, Shenzhen City (CN)

(73) Assignee: TENCENT TECHNOLOGY (SHENZHEN) COMPANY LIMITED, Shenzhen City (CN)

(21) Appl. No.: 13/442,984

(22) Filed: Apr. 10, 2012

Related U.S. Application Data
(63) Continuation of application No. PCT/CN2010/074535, filed on Jun. 25, 2010.

(30) Foreign Application Priority Data
Oct. 13, 2009 (CN) 200910175762.4

(51) Int. Cl. G06Q 20/08

(52) U.S. Cl. 705/39

(57) ABSTRACT

A search engine system includes a search module, an entrance for data submission by data providers, a resource library, and a payment module. The search module is configured to receive an information search request, search for corresponding data information from the resource library, send a payment request to the payment module after receiving a request for viewing the data information, and display or output the data information after receiving an indication of successful payment. The entrance for data submission by data providers is configured to the specialized data providers to submit data information to the resource library. The payment module is configured to receive the payment request, check corresponding account according to account information carrying in the payment request and deduct fees corresponding to the data information from the account, and send the indication of successful payment to the search module after the deduction is successful.

### CROSS-REFERENCE TO RELATED APPLICATIONS

This application is a continuation of International Application No. PCT/CN2010/074535, filed on Jun. 25, 2010. This application claims the benefit and priority of Chinese Patent Application No. 200910175762.4, filed Oct. 13, 2009. The entire disclosures of each of the above applications are incorporated herein by reference.

### FIELD

The present disclosure relates to internet technology, a search engine system, and an information searching method.

### BACKGROUND

This section provides background information related to the present disclosure which is not necessarily prior art.

A typical search engine system usually includes a search module, a ranking module and a display module.

The search module is configured to receive information search requests, and search for data information relevant to the information search requests from the open data on the internet and send the searched data information to the ranking module.

The ranking module is configured to rank the data information sent from the search module and send the ranked results and the data information to the display module.

The display module is configured to directly display the data information or links to the data information sent from the ranking module.

The open data on the internet refers to the data information such as web pages freely available to the public. In other words, any one has the authority to access to the open data.

In addition to the open data, there is a lot of deep web data on the internet. The deep web data refers to web that the typical search engines can not capture or information that the typical search engines cannot search, i.e. the data on “invisible” websites. The “invisible” websites can be divided into two types: one type is that websites themselves are nonstandard or that the internet itself lacks a uniform standard, which causes the web crawler of the search engine unable to identify and grab contents of these websites, and the other type is that websites themselves use specific techniques to prevent search engines from searching data information on them in order to protect intellectual properties, individual privacy or other contents, such as websites of specialized data providers.

The website of a specialized data provider refers to a website which possesses data resource of specific areas or special types and which provides data services on a for-profit basis, such as Wanfang digital database and ACM digital library. To acquire the detailed data information on these websites, users have to register respectively in corresponding websites and pay in one lump sum for a certain authority to obtain certain authority and then obtain corresponding detailed data information through logging in the corresponding websites.

At present, there are a large number of such websites of the specialized data providers on the internet, in which the information contained is significant and is also of great value to many search engine users. However, on the one hand, the typical search engines cannot grasp the detailed data on the websites of the specialized data providers, and cannot thus be able to provide users with complete data information. On the other hand, even though summaries of data information may be searched by the search engine, the user can determine detailed data information needed to be obtained according to the summaries, and the user can obtain the detailed data information only after a series of operations including logging in the corresponding website, registering and paying and so on; and this is extremely inconvenient for web users. Meanwhile, frequent operations such as logging in, registering and paying also take up a large amount of web resources.

### SUMMARY

This section provides a general summary of the disclosure, and is not a comprehensive disclosure of its full scope or all of its features.

In view of this, an object of one embodiment is to present a search engine system and an information searching method, which can search more comprehensive data information for web users while saving web resources.

In order to achieve the aforementioned object, the technical solution of the one embodiment is specifically implemented as follows:

A search engine system, which includes a search module, an entrance for data submission by data providers, a resource library and a payment module;

the search module is configured to receive an information search request, find out corresponding data information from the resource library according to the information search request, send a payment request to the payment module after receiving a request to view the data information, and display or output the data which is requested to view after receiving an indication of successful payment sent from the payment module;

the entrance for data submission by data providers, which is connected with the resource library, is used for the specialized data providers to submit data information to the resource library;

the resource library is configured to receive and store data information submitted by the specialized data providers;

the payment module is configured to receive the payment request sent from the search module, check corresponding account according to account information carrying in the payment request and deduct fee corresponding to the data information which is requested to view from the account, and send the indication of successful payment to the search module after the deduction is successful.

An information searching method comprises:

establishing a first entrance for data providers to submit data information;

receiving and storing the data information submitted by the data providers via the first entrance;

receiving an information search request, searching for corresponding information from the stored data information according to the information search request, receiving a request to view the information, and displaying or outputting the information which is requested to view after payment has been made for the information.

It can be seen that the search engine system receives data information submitted by specialized data providers via an entrance set for the data providers and stores the data information submitted by specialized data providers by setting up a specific resource library. Through searching the data information of the resource library, the search engine system can find the data information which is invisible to traditional search engine technology, so that the search engine system can search more comprehensive information.

On the other hand, by the presence of the payment module, the users can pay to all specialized data providers that submit data to the search engine system for the information which is requested to view via the payment module, thus eliminating the need to frequently log in to the different websites of different specialized data providers. This not only provides convenience to users but also saves web resources.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a first layout of a search engine system.

FIG. 2 is a schematic diagram of a second layout of the search engine system.

FIG. 3 is a schematic diagram of a detailed layout of the search engine system.

FIG. 4 is a flow chart of an information searching method.

FIG. 5 is a flow chart of a method to submit data information to the search engine system.

FIG. 6 is a flow chart of a method to search for data information.

Corresponding reference numerals indicate corresponding parts throughout the several views of the drawings.

### DETAILED DESCRIPTION

In order to make objects, technical solutions, and advantages clear, the present invention is hereinafter further explained in details with reference to embodiments and drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

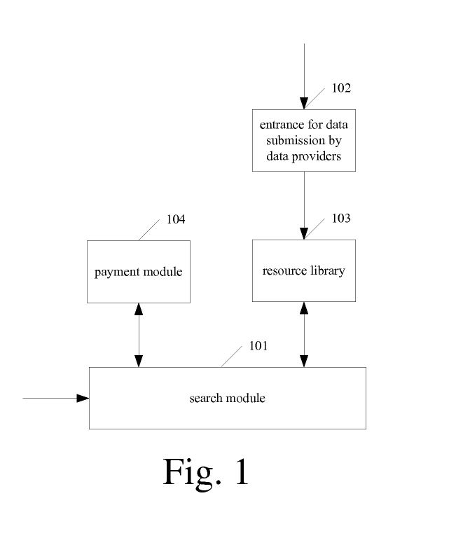

FIG. 1 is a schematic diagram of a first layout of a search engine system. As shown in FIG. 1, the system includes a search module 101, an entrance for data submission by data providers 102, a resource library 103, and a payment module 104.

The search module 101 is configured to receive an information search request, search for corresponding data information from the resource library 103 according to the information search request, send a payment request to the payment module 104 after receiving a request to view the data information, and display or output the data which is requested to view after receiving an indication of successful payment sent from the payment module 104.

The entrance for data submission by data providers 102 is connected with the resource library 103 and is used for specialized data providers to submit data information to the resource library 103.

The resource library 103 is configured to receive and store data information submitted by the specialized data providers.

The payment module 104 is configured to receive the payment request sent from the search module 101, check a corresponding account according to account information carrying in the payment request and deduct the corresponding fees for the data information which is requested to view from the account, and send the indication of successful payment to the search module 101 after the deduction is successful.

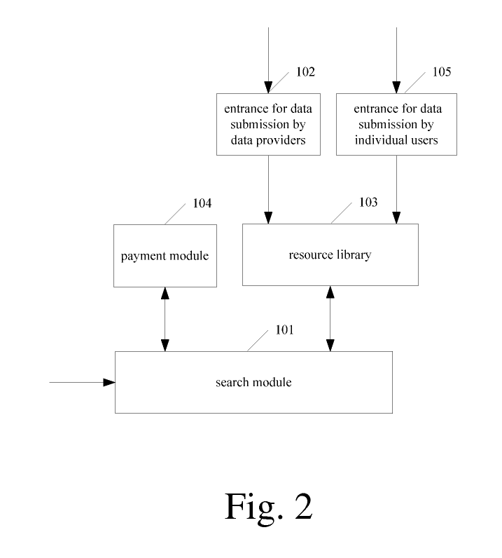

FIG. 2 is a schematic diagram of a second layout of the search engine system. As shown in FIG. 2, on the basis of the system shown in FIG. 1, the system further includes an entrance for data submission by individual users 105.

The entrance for data submission by individual users 105 is connected with the resource library 103 and is used for the individual users to submit data information to the resource library 103.

The resource library 103 is further configured to receive and store data information submitted by the individual users.

By the presence of the entrance for data submission by individual users 105, any web user can submit data to the resource library 103 through the entrance for data submission by individual users 105, so that the search engine system can search more comprehensive data information.

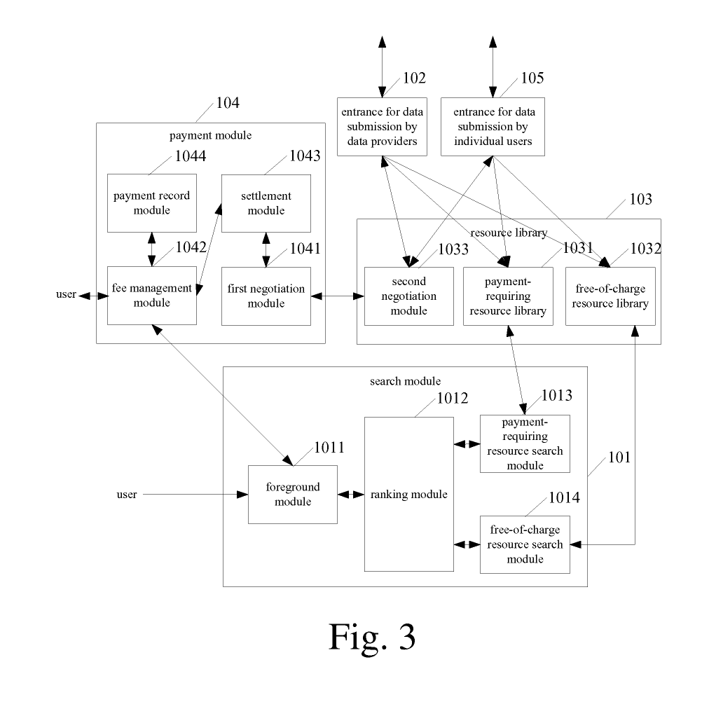

In the specific implementation of the search engine system shown in FIG. 2, any one or more of the search module 101, the resource library 103 and the payment module 104 can be further detailed. The specific implementation of the search engine system is illustrated in the following with each of the search module 101, the resource library 103 and the payment module 104 being detailed, and the details are shown in FIG. 3.

FIG. 3 is a schematic diagram of a detailed layout of the search engine system. The system as shown in FIG. 3 shows details of each modules of the system shown in FIG. 2, which specifically include:

the resource library 103 includes a payment-requiring resource library 1031, a free-of-charge resource library 1032 and a second negotiation module 1033; the search module 101 includes a foreground module 1011, a ranking module 1012, a payment-requiring resource search module 1013 and a free-of-charge resource search module 1014; the payment module 104 includes a first negotiation module 1041, a fee management module 1042, a settlement module 1043 and a payment record module 1044.

The payment-requiring resource library 1031 is configured to receive and store data information that is submitted by individual users or specialized data providers and that requires payment to view.

The free-of-charge resource library 1032 is configured to receive and store data that is submitted by individual users or specialized data providers and that does not require payment to view.

The foreground module 1011 is configured to receive an information search request, send a search command to the payment-requiring resource search module 1013 or the free-of-charge resource search module 1014 according to the information search request, send a ranking command to the ranking module 1012 and receive data information sent from the ranking module 1012, display the summary of the data information, send a payment request to the payment module 104 after receiving a request to view the payment-requiring data information, and display or output the data information or link(s) to the data information which is requested to view after receiving an indication of successful payment sent from the payment module 104.

The ranking module 1012 is configured to receive data information sent from the payment-requiring resource search module 1013 and/or the free-of-charge resource search module 1014, rank the received data information according to the ranking command sent from the foreground module 1011, and send the ranked data information to the foreground module 1011.

The payment-requiring resource search module 1013 is configured to search corresponding charged data information from the payment-requiring resource library 1031 and sent it to the ranking module 1012 after receiving the search command sent from the foreground module 1011.

The free-of-charge resource search module 1014 is configured to search corresponding free-of-charge data information from the free-of-charge resource library 1032 and send it the ranking module 1012 after receiving the search command from the foreground module 1011.

The first negotiation module 1041 is configured to receive revenue-sharing agreement sent from the second negotiation module 1033 and send an acknowledgement indication to the second negotiation module 1033.

The second negotiation module 1033 is configured to negotiate the revenue-sharing agreement with individual users or data providers via the entrance for data submission by individual users 105 or the entrance for data submission by data providers 102, send the revenue-sharing agreement to the first negotiation module 1041 after receiving a trigger indicating approval of the revenue-sharing agreement, and display or output an acknowledgement information via the entrance for data submission by individual users 105 or the entrance for data submission by data providers 102 after receiving the acknowledgement indication from the first negotiation module 1041.

After receiving the payment request sent from the search module 101, the fee management module 1042 checks whether the balance of the account corresponding to the payment request is greater than the amount of fee corresponding to the payment request, deducts the corresponding fee from the account if the balance is enough to cover the fee, and then sends the indication of successful payment to the search module 101.

The settlement module 1043, which is connected with the first negotiation module 1041 and the fee management module 1042, is configured to obtain information on the fees deducted by the fee management module 1042, the data information for which the fees are paid, information of the individual users or data providers who submit the data resource corresponding to the data information and the revenue-sharing agreement stored by the first negotiation module 1041, and settle revenues for the accounts corresponding to information of the individual user or the data provider according to the revenue-sharing agreement as well as the amounts of the fees concerned.

After receiving the payment request sent from the search module 101, the fee management module 1042 inquires about the successively paid data resource information recorded in the payment record module 1044, if it is determined that corresponding account does not pay for the data information which is requested to view, deducts the fee corresponding to the data information which is requested to view, and sends the indication of successful payment to the search module 101 after the corresponding account has paid for the data information which is requested to view.

The payment record module 1044 is configured to record the successively paid data resource information by the fee management module 1042 as well as the corresponding account information.

In order to improve the security of data resource (i.e., data information) submitted by individual users or specialized data providers, the resource library 103 can be further configured to check the validity of received data resource and store the data resource after the validity check is successful. The validity check can be done using either existing techniques or other methods and the present embodiment does not limit this.

In the above system, data submitted by individual users and/or specialized data providers includes textual data, audio and/or video data containing descriptive information or valid links directing to the said textual data or audio and/or video data. Depending on the difference of the type and/or volume of the data submitted, the search system can provide different web resources such as network bandwidth for entrance for data submission by individual users and/or data providers, for example, providing broad bandwidth for the submitted video data, or broad bandwidth and storage space for specialized data providers who submit large amounts of data.

The payment module 104 in the above system can also include a module for account recharging, transfer or money withdrawing. The resource library 103 can also include a module for individual users or specialized data providers to update and/or delete data information submitted to the resource library 103. The ranking module 1012 can adopt different algorithms to calculate relevance for the charged resource and the free of charge resource. The fee management module 1042 can be configured to remind users to recharge their accounts before accessing when the balances of the accounts are not enough.

Further, the present embodiment also uses a particular ranking method to rank data information including both of the charged resource and the free of charge resource, to allow data information of greater value to users to be displayed at front position of all the searched data information.

Specifically, the ranking module 1012 acquires weights assigned in advance for the relevance between charged resources and information search requests, and the numbers of clicks on the charged resources and comments, then weighs the charged resources according to the weights, the actual relevance between the charged resources and the information search request, and the actual numbers of clicks on the charged resources and comments, and ranks the charged resources based on the weighted results.

The ranking module 1012 can further include a module configured to judge whether the actual relevance between the charged resources and the information search request is greater than a predetermined value, and ranking the charged resources only when the actual relevance between the charged resources and the information search request is greater than the predetermined value.

The ranking module 1012 can also rank the charged resources, which are ranked before a predetermined position of all the charged resources, before all the free of charge resource.

The following will make a detailed explanation about the ranking method of the ranking module 1012.

The ranking module 1012 can mix ranked charged resources and free of charge resources. Different ranking weights (i.e. ranking factor) can be set for the charged resources and the free of charge resources, and weighted results of the charged resources and the free of charge resources can be calculated, respectively, and the charged resources and the free of charge resources can be mixed ranking based on the weighted results.

Preferably, the weighted results for the charged resources can be obtained through the following formula:

Rank_{charged fee}=P1×Rank_{Clicks}+P2×Rank_{Comments}+P3×Rank_{Relevance}

wherein, Rank_{charged fee} is the weighted result; P1, P2 and P3 are the weights for the number of users' clicks, rating of comments on the charged resources and the relevance between the charged resources, respectively, and the information search request; and P1+P2+P3=1.

Rank_{Clicks} is a ranking value calculated based on the number of clicks on the charged resources by users. The more users click on the charged resources, the higher the Rank_{Clicks} of the charged resources will be.

Rank_{Comments} is a ranking value calculated based on the rating of actual comments of the charged resources of users. The higher the rating of the comments of the charged resources of users is, the higher the Rank_{Comment} of the charged resources will be.

Rank_{Relevance} is a ranking value calculated based on the actual relevance between the charged resources and the information search request, the higher the relevance between the two, the higher the Rank_{Relevance} of the charged resources will be.

According to above calculation method, every search result from the payment-requiring resource search module has a weighted result. We pick the first N highest weighted results out and place them in front of the search results from other data search modules. N can be any natural number, e.g. 3.

In order to screen out charged resources with too low relevance, a threshold can be set for the Rank_{Relevance} of the charged resources. If the Rank_{Relevance} is lower than the pre-set threshold, the corresponding charged resources will not be displayed. This not only prevents irrelevant charged data from disturbing users, but can also ensure that the first N pertinent charged resources can be displayed at the top for the user to choose.

The payment module 104 allows deduction of small amounts of money from users' accounts, i.e., the amount of the money each deducted from the account of the user can be smaller, e.g. 0.5 RMB each time.

In short, the search engine system allows any user or a third-party data provider to submit valuable resources to the search engine, and the search engine will display some of the resources to other users who are searching based on factors such as relevance. If the users who are searching are willing to pay for these resources, they can just click on these resources and obtain these resources from the search engine after payment is made through the background payment module.

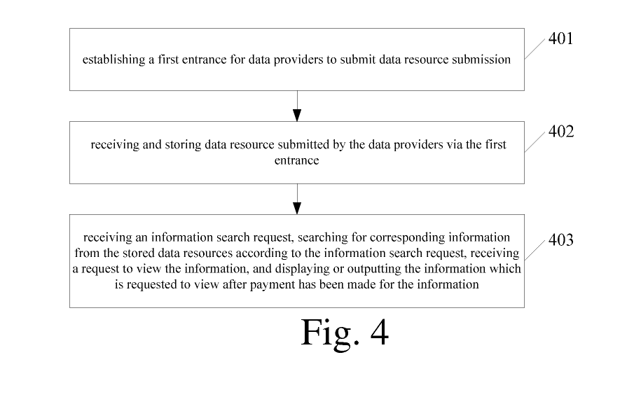

Referring to FIG. 4, the present embodiment provides an information searching method corresponding to the search engine system described above.

FIG. 4 is a flow chart of an information searching method. As shown in FIG. 4, the method includes:

Block 401: establishing a first entrance for data providers to submit data resource submission.

Block 402: receiving and storing data resource submitted by the data providers via the first entrance.

Block 403: receiving an information search request, searching for corresponding information from the stored data resources according to the information search request, receiving a request to view the information, and displaying or outputting the information which is requested to view after payment has been made for the information.

The method can further include: establishing a second entrance for individual users to submit data resource, and receiving and storing data resource submitted by the individual users via the second entrance.

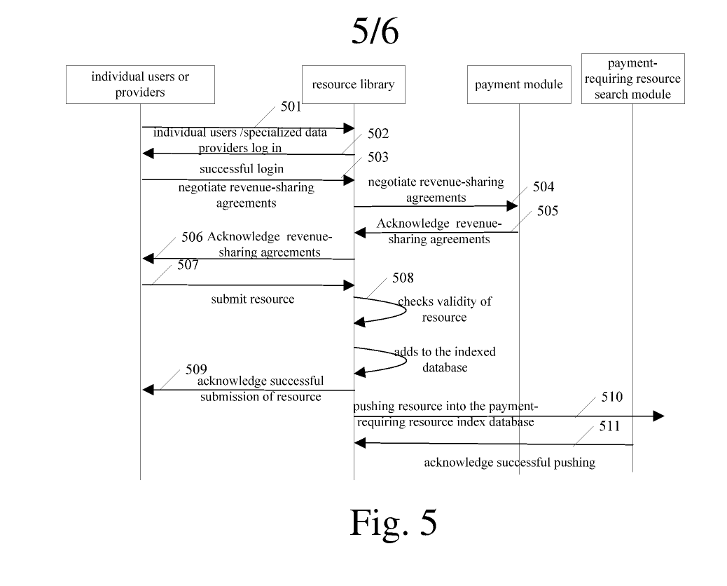

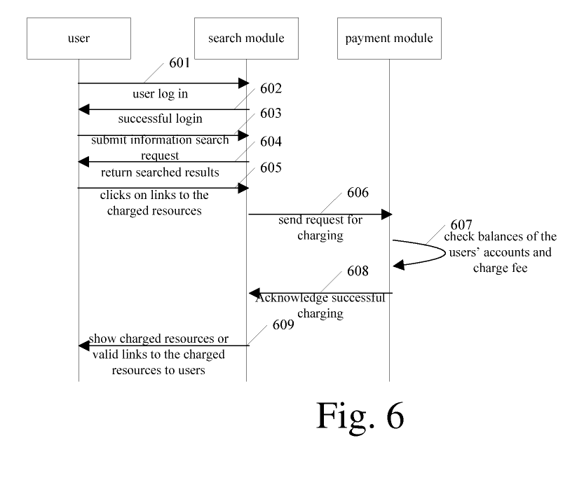

The following will describe a method to submit data information to the search engine system and to search data information, the details are shown in FIG. 5 and FIG. 6.

FIG. 5 is a flow chart of a method to submit data information to the search engine system. As shown in FIG. 5, the method includes:

Blocks 501-502: individual users or specialized data providers log in the resource library via the corresponding entrances for data submission.

Blocks 503-506: individual users or specialized data providers negotiate revenue-sharing agreements with the resource library via the corresponding entrances for data submission, the resource library sends the agreed revenue-sharing agreements to the payment module, and the payment module sends a message acknowledging the agreements to the individual users or specialized data providers via the resource library after receiving the revenue-sharing agreements,

Block 507: individual users or specialized data providers submit data information to the resource library via the corresponding entrances for data submission.

Block 508: the resource library receives and checks validity of data resource information, and adds the data resource information to the indexed database in the resource library after the validity check is successful.

Block 509: the resource library sends a message of acknowledging successful submission of resource to individual users or specialized data providers via the corresponding entrances for data submission.

Blocks 510-511: the resource library sends a request to the payment-requiring resource search module to push the resource submitted by individual users or specialized data providers into the payment-requiring resource index database in the payment-requiring resource search module. The payment-requiring resource search module sends a message of acknowledging successful pushing to the resource library after pushing the submitted resource into the payment-requiring resource index database.

FIG. 6 is a flow chart of a method to search for data information. As shown in FIG. 6, the method includes:

Blocks 601-602: search engine users log in the search module.

Blocks 603-604: the search engine users submit an information search request to the search engine system and the search module returns the searched results to the search engine users.

Blocks 605-608: the search module receives the search engine users' clicks on the links to the charged resources and sends a request for charging corresponding to the charged resource to the payment module. The payment module checks whether the balances of the users' accounts is enough, the fee is deducted if the balances are enough, and sends a message indicating that payment has been made to the search module.

Block 609: the search module shows charged resources or valid links to the charged resources to the search engine users.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A search engine system comprising: a search module, an entrance for data submission by data providers, a resource library and a payment module;
wherein the search module is configured to receive an information search request, search for corresponding data information from the resource library according to the information search request, send a payment request to the payment module after receiving a request for viewing the data information, and display or output the data information which is requested to view after receiving an indication of successful payment sent from the payment module;
the entrance for data submission by data providers, which is connected with the resource library, is configured to the specialized data providers to submit data information to the resource library;
the resource library is configured to receive and store data information submitted by the specialized data providers;
the payment module is configured to receive the payment request sent from the search module, check corresponding account according to account information carrying in the payment request and deduct fee corresponding to the data information which is requested to view from the account, and send the indication of successful payment to the search module after the deduction is successful.

2. The system according to claim 1, further comprising an entrance for data submission by individual users, which is connected with the resource library and configured to the individual users to submit data information to the resource library;
wherein the resource library is configured to receive and store the data information submitted by the individual users.

3. The system according to claim 2, wherein the resource library comprises a payment-requiring resource library and a free-of-charge resource library; the search module comprises a foreground module, a ranking module, a payment-requiring resource search module and a free-of-charge resource search module;
wherein the payment-requiring resource library is configured to receive and store payment-requiring data information submitted by the individual users or the specialized data providers;
the free-of-charge resource library is configured to receive and store free-of-charge data information submitted by the individual users or the specialized data providers;
the foreground module is configured to receive the information search request, send a search command to the payment-requiring resource search module or the free-of-charge resource search module according to the information search request, send a ranking command to the ranking module, receive data information sent from the ranking module, display summary of the data information, send a payment request to the payment module after receiving a request to view the payment-requiring data, and display or output the data information or link to the data information which is requested to view after receiving the indication of successful payment sent from the payment module;
the ranking module is configured to receive data information sent from the payment-requiring resource search module and/or the free-of-charge resource search module, rank the received data information according to the ranking command sent from the foreground module, and send the ranked data information to the foreground module;
the payment-requiring resource search module is configured to search for corresponding payment-requiring data information from the payment-requiring resource library after receiving the search command sent from the foreground module and send the searched corresponding payment-requiring data information to the ranking module;
the free-of-charge resource search module is configured to search for corresponding free-of-charge data information from the free-of-charge resource library after receiving the search command sent from the foreground module and send the searched corresponding free-of-charge data information to the ranking module.

4. The system according to claim 2, wherein the payment module comprises a first negotiation module, a fee management module and a settlement module; the resource library further comprises a second negotiation module;
wherein the first negotiation module is configured to receive a revenue-sharing agreement sent from the second negotiation module and send an acknowledgement indication to the second negotiation module;
the second negotiation module is configured to negotiate the revenue-sharing agreement with the individual users or the data providers via the entrance for data submission by the individual users or data providers, send the revenue-sharing agreement to the first negotiation module after receiving a trigger indicating approvement of the revenue-sharing agreement, and display or output an acknowledgement information via the entrance for data submission by the individual users or data providers after receiving the acknowledgement indication sent from the first negotiation module;
after receiving the payment request from the search module, the fee management module checks whether balance of the account corresponding to the payment request is greater than amount of the fee, deducts the fee from the account if the balance is enough to cover the fee and then sends the indication of successful payment to the search module;
the settlement module, which is connected with the first negotiation module and the fee management module, is configured to obtain information on the fees deducted by the fee management module, the data information for which the fees are paid, information of the individual users or data providers who submit the data resource corresponding to the data information and the revenue-sharing agreement stored by the first negotiation module, and settle revenues for the accounts corresponding to information of the individual user or the data provider according to the revenue-sharing agreement as well as the amounts of the fees concerned.

5. The system according to claim 4, wherein the payment module further comprises a payment record module;
wherein the fee management module receives the payment request sent from the search module; according to the account information carrying in the payment request, the fee management module inquires about successively paid data resource information recorded in the payment record module, if it is determined that corresponding account does not pay for the data information which is requested to view, deducts the fee corresponding to the data information which is requested to view, and sends the indication of successful payment to the search module after the corresponding account has paid for the data information which is requested to view;
the payment record module is configured to record the successively paid data resource information by the fee management module as well as the corresponding account information.

6. The system according to claim 2, wherein the resource library is configured to receive and checks validity of data information submitted by the individual users or specialized data providers, and store the data information after the validity check is successful.

7. The system according to claim 6, wherein the data information includes textual data, audio and/or video data containing descriptive information or valid links directing to the textual data or audio and/or video data.

8. The system according to claim 3, wherein the ranking module acquires weights assigned in advance for the relevance between payment-requiring resources and the information search request, and the numbers of clicks on the payment-requiring resources and comments, then weights the payment-requiring resources according to the weights, the actual relevance between the payment-requiring and the information search request, and the actual numbers of clicks on the payment-requiring resources and comments, and ranks the payment-requiring resources based on the weighted results.

9. The system according to claim 8, wherein the ranking module further comprises a module configured to judge whether the actual relevance between the payment-requiring resources and the information search request is greater than a predetermined value, and ranking the payment-requiring resources only when the actual relevance between the payment-requiring resources and the information search request is greater is greater than the predetermined value.

10. The system according to claim 8, wherein the ranking module ranks payment-requiring resources, which are ranked before a pre-determined position of all the payment-requiring resources, before all the free of charge resource.

11. The system according to claim 9, wherein the ranking module ranks payment-requiring resources, which are ranked before a pre-determined position of all the payment-requiring resources, before all the free of charge resource.

12. An information searching method comprises:
establishing a first entrance for data providers to submit data information;
receiving and storing the data information submitted by the data providers via the first entrance;
receiving an information search request, searching for corresponding information from the stored data information according to the information search request, receiving a request to view the information, and displaying or outputting the information which is requested to view after payment has been made for the information.

13. The method according to claim 12, further comprising:
establishing a second entrance for individual users to submit data information;
receiving and storing the data information submitted by the individual users via the second entrance.

14. A search engine system comprising:
a resource library configured to receive and store data information;
an entrance for data submission connected with the resource library and configured to a supplier to submit data information to the resource library;
two negotiation modules, wherein one of the two negotiation modules is configured to negotiate a revenue-sharing agreement with the supplier via the entrance for data submission and send the revenue-sharing agreement to the other one of the two negotiation modules after receiving a trigger indicating approvement of the revenue-sharing agreement; the other one of the two negotiation modules is configured to receive and store the revenue-sharing agreement sent from the one of the two negotiation modules and send an acknowledgement indication to the one of the two negotiation modules; the one of the two negotiation modules is further configured to display or output the acknowledgement information via the entrance for data submission after receiving the acknowledgement indication sent from the other one of the two negotiation modules;
a fee management module configured to receive a payment request carrying account information, deduct fee from corresponding account according to the account information if balance of the corresponding account is enough after receiving the payment request and send an indication whether payment is successful;
a search module configured to receive an information search request, search for corresponding data information from the resource library according to the information search request, send the payment request to the fee management module after receiving a request for viewing the corresponding data information, and display or output the corresponding data information after receiving an indication of successful payment sent from the fee management module; and
a settlement module, which is connected with the other one of the two negotiation modules and the fee management module, configured to obtain information on the fee deducted by the fee management module, the corresponding data information, information of the supplier who submits data resource corresponding to the corresponding data information and the revenue-sharing agreement stored by the other one of the two negotiation modules, and settle revenues for an account corresponding to information of the supplier according to the revenue-sharing agreement as well as the amounts of the fees concerned.

15. The system according to claim 14, wherein the supplier comprises at least one of data providers and individual users.

16. The system according to claim 14, further comprising a payment record module; wherein the fee management module receives the payment request sent from the search module; according to the account information carrying in the payment request, the fee management module inquires about successively paid data resource information recorded in the payment record module, if it is determined that corresponding account does not pay for data information which is requested to view, deducts fee corresponding to the data information which is requested to view, and sends the indication of successful payment to the search module after the corresponding account has paid for the data information which is requested to view; the payment record module is configured to record the successively paid data resource information by the fee management module as well as the corresponding account information.
